(19) United States
(12) Patent Application Publication
(10) Pub. No.: US 2025/0124634 A1
(43) Pub. Date: Apr. 17, 2025

(54) THREE-DIMENSIONAL HAND AND OBJECT MOTION SYNTHESIS

(71) Applicant: GOOGLE LLC, Mountain View, CA (US)

(72) Inventors: Thabo Beeler, Egg (CH); Jan Bednarík, Zurich (CH); Bardia Doosti, Toronto (CA); Bernd Bickel, Zurich (CH); Danhang Tang, West Hollywood, CA (US); Jonathan James Taylor, New York City, NY (US); Soshi Shimada, Saarbrücken (DE); Franziska Müller, Oberlunkhofen (CH)

(21) Appl. No.: 18/917,512

(22) Filed: Oct. 16, 2024

Related U.S. Application Data
(60) Provisional application No. 63/590,555, filed on Oct. 16, 2023.

(51) Int. Cl. G06T 13/40; G06T 5/60; G06T 5/70

(52) U.S. Cl. CPC G06T 13/40; G06T 5/60; G06T 5/70; G06T 2207/20081; G06T 2207/20084

(57) ABSTRACT

A method includes determining a trajectory of an object based on a mass of the object, and determining a motion of a hand based on the mass of the object and the trajectory of the object. The method can further include generating an animation of the hand interacting with the object based on the trajectory of the object and the motion of the hand.

### CROSS-REFERENCE TO RELATED APPLICATION

This application claims priority to U.S. Provisional Application No. 63/590,555, filed on Oct. 16, 2023, entitled, “THREE-DIMENSIONAL HAND AND OBJECT MOTION SYNTHESIS,” which is incorporated herein by reference in its entirety.

### BACKGROUND

Physical properties of objects, such as mass, affect how persons interact with the objects. Generating animations of interactions between persons and objects that reflect the physical properties can be difficult.

### SUMMARY

Physical properties of objects, such as mass, affect how the objects move as well as how persons interact with the objects. A realistic-appearing animation will take into account the mass of an object included in the animation. A system, which generates an animation, determines a trajectory of an object based on a mass of the object. The system then determines a motion of a hand interacting with the object based on the trajectory and the mass of the object. The system generates an animation of the hand interacting with the object based on the trajectory of the object and the motion of the hand. The system can determine the trajectory of the object and/or the motion of the hand by applying a generative model such as a diffusion model.

According to an example, a method includes determining a trajectory of an object based on a mass of the object, and determining a motion of a hand based on the mass of the object and the trajectory of the object.

According to an example, a non-transitory computer-readable storage medium comprises instructions stored thereon. When executed by at least one processor, the instructions are configured to cause a computing system to determine a trajectory of an object based on a mass of the object, determine a motion of a hand based on the mass of the object and the trajectory of the object, and generate an animation of the hand interacting with the object based on the trajectory of the object and the motion of the hand.

According to an example, a computing system includes at least one processor and a non-transitory computer-readable storage medium comprising instructions stored thereon. When executed by the at least one processor, the instructions are configured to cause the computing system to determine a trajectory of an object based on a mass of the object, determine a motion of a hand based on the mass of the object and the trajectory of the object, and generate an animation of the hand interacting with the object based on the trajectory of the object and the motion of the hand.

The details of one or more implementations are set forth in the accompanying drawings and the description below. Other features will be apparent from the description and drawings, and from the claims.

### BRIEF DESCRIPTION OF THE DRAWINGS

FIG. 1 is an image from an animation showing a hand interacting with an object.

FIGS. 2A and 2B are schematic diagrams of a system for generating an animation of a hand interacting with an object based on a mass of the object.

FIGS. 3A through 6B show animations of hands interacting with objects. FIGS. 3A, 4A, 5A, and 6A show animations of hands interacting with objects that have a relatively low mass, and FIGS. 3B, 4B, 5B, and 6B show animations of hands interacting with objects that have relatively high mass.

FIGS. 7A through 7E show hands holding spherical objects with sequentially greater masses.

FIG. 8 shows a user input trajectory processing stage.

FIG. 9A shows a visualization of template vertices of an object.

FIG. 9B shows an image of a sphere.

FIG. 10 is a block diagram of a computing system for generating an animation of a hand interacting with an object based on a mass of the object.

FIG. 11 is a flowchart showing a method for generating an animation of a hand interacting with an object based on a mass of the object.

FIG. 12 is a flowchart showing a method for generating an animation of a hand interacting with an object.

Like reference numbers refer to like elements.

### DETAILED DESCRIPTION

Physical properties of objects, such as mass, affect how persons interact with the objects. For example, a person may hold a light object with fingertips of the person's hand, whereas a person may hold a heavy object by extending entire fingers of the person's hand around the object. At least one technical problem with generating animations of persons interacting with objects (e.g., virtual objects, objects in an augmented reality (AR) environment, or object in a computer-generated cartoon) is that the generated animations may not take into account the mass of the objects. Accordingly, movement of the objects, when animated, may not be realistic and/or behave as they would in the real world.

At least one technical solution to at least this technical problem, mentioned above, is to determine a trajectory of an object based on a mass of the object and/or determine a motion of a hand based the mass of the object and the trajectory of the object. The technical solutions described herein can also include generating an animation of the hand interacting with the object based on the trajectory of the object and the motion of the hand.

The technical solutions noted above have at least the technical benefit of generating a realistic-looking animation of a person interacting with an object that reflects the mass of the object. The mass of the object affects the trajectory of the object and/or the way the hand (or hands) grasp the object. For example, a number of contact points between the hand and the object can be a function of the mass of the object, with the number of contact points increasing as the mass of the object increases. The generated animations can be provided as synthetic training data for machine learning tasks, for fast animation of hands for graphics workflows, and/or for generating character interactions for computer games.

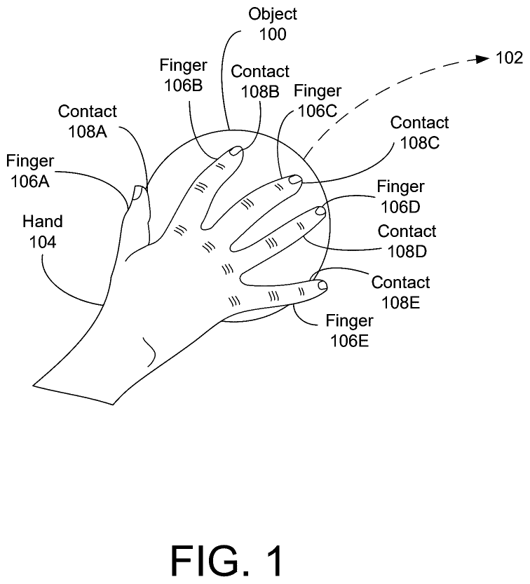

FIG. 1 is an image from an animation showing a hand 104 interacting with an object 100. A trajectory 102 of the object 100 is shown by an arrow. A computing system can determine the trajectory 102 of the object 100 based on a mass of the object 100. In some implementations, the computing system determines the trajectory 102 of the object 100 based on the mass of the object 100 and an action performed on the object 100 by the hand 104, such as the hand 104 throwing, turning, or lifting the object 100. The action performed on the object 100 by the hand 104 can be considered an action type. The action type can characterize an action of the hand (such as throwing, turning, grabbing, holding, lifting, or rotating the object 100). In some implementations, the trajectory 102 includes displacement of the object 100 from an initial location to a final location along a straight line, an arc, or any other path. In some implementations, the trajectory 102 includes rotation of the object 100.

The hand 104 interacts with the object 100, such as by performing an action including holding, turning, moving, or throwing the object 100. The hand 104 includes fingers, such as a thumb 106A, a forefinger 106B, a middle finger 106C, a ring finger 106D, and a little finger 106E. The fingers 106A, 106B, 106C, 106D, 106E contact the object 100. A first contact 108A represents points of contact between the thumb 106A and the object 100. A second contact 108B represents points of contact between the forefinger 106B and the object 100. A third contact 108C represents points of contact between the middle finger 106C and the object 100. A fourth contact 108D represents points of contact between the ring finger 106D and the object 100. A fifth contact 108E represents points of contact between the little finger 106E and the object 100.

A number of points of contact, and/or an area of contact, between the fingers 106A, 106B, 106C, 106D, 106E and the object 100 can be a function of the mass of the object 100. For example, a person may be able to hold a light (or less massive) object by contacting the object with only tips of fingers, whereas a person may need to grip or squeeze a heavy (or more massive) object by contacting the object with a majority of inner portions of fingers. Similarly, a person may be able to rotate or throw a light (or less massive) object with fewer contact points between fingers and the object, whereas a person may need to contact a heavy (or more massive) object with many contact points of a hand or both hands to rotate or throw the heavy (or more massive) object.

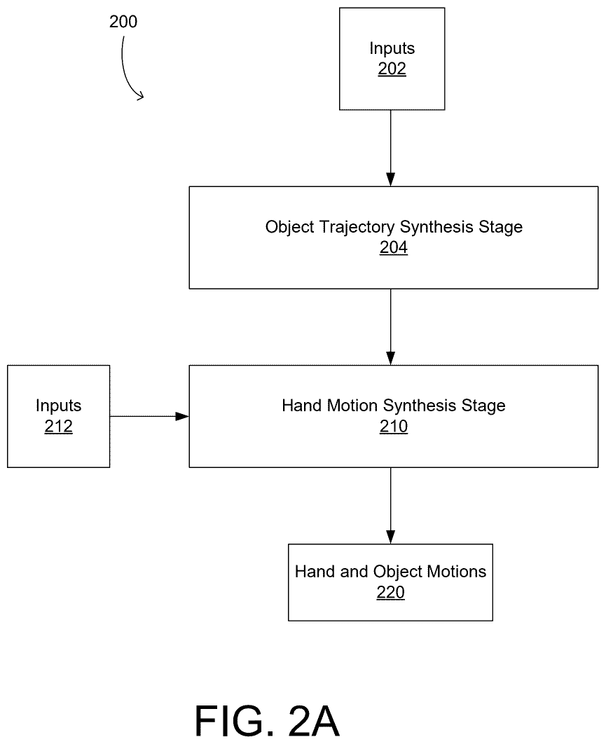

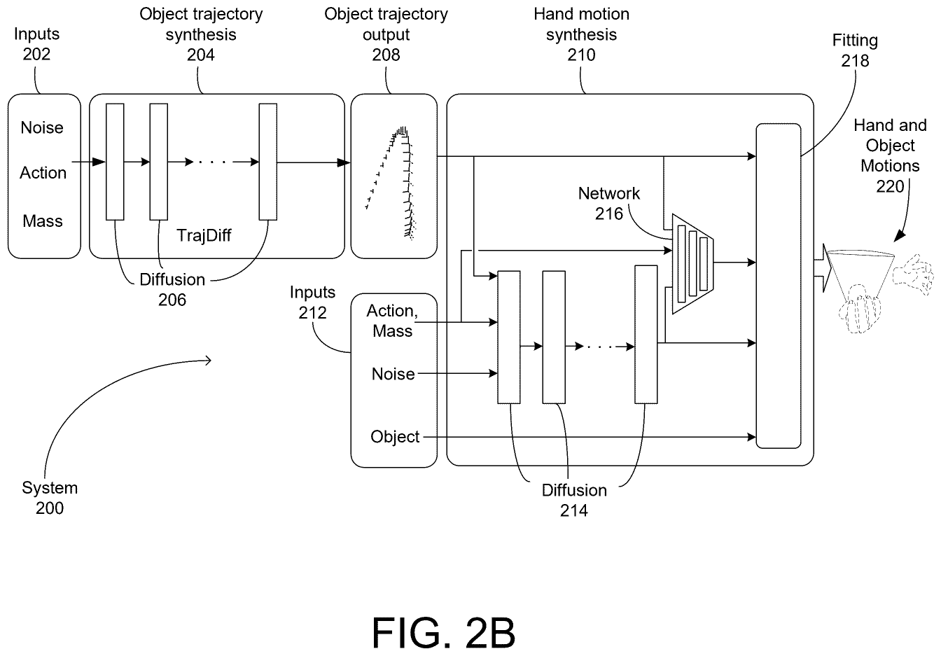

FIG. 2A is a schematic diagram of a system 200 for generating an animation of a hand (such as the hand 104 shown in FIG. 1) interacting with an object (such as the object 100) based on a mass of the object. The animation can include a trajectory of an object and motion of the hand.

The system 200 can include an object trajectory synthesis stage 204 that determines and/or generates a trajectory of an object and a hand motion synthesis stage 210 that determines and/or generates motion of the hand or hands. The trajectory of the object includes a motion and/or path of the object. The trajectory of the object can include locations and/or orientations of the object at multiple different times.

The hand motion synthesis stage 210 can generate hand and object motions 220. In some implementations, the hand and object motions 220 comprise an animation of the hand or hands interacting with the object. The hand and object motions 220 include motions and/or animations of the hand or hands with respect to the object. The motions can include, for example, holding, grabbing, turning, pushing, and/or throwing the object. Motion of the hand can include displacement of the hand (such as a change of location of the hand) and/or movement of the hand associated with holding, grasping, grabbing, turning, pushing, and/or throwing by the hand while the hand maintains a same location.

The object trajectory synthesis stage 204 determines the trajectory of the object 100 based on inputs 202 such as noise, an action, and/or a mass of the object. The noise can be random noise that causes the object trajectory synthesis stage 204 to generate different trajectories of the object 100 with same action and mass inputs in a non-deterministic manner. The noise can be added at multiple steps along the path of the trajectory, such as making random changes to the location and/or orientation of the object 100. The noise can be cumulative, with multiple instances of noise in a same direction causing the object to be located further in that direction by adding the instances of the noise in that same direction, for example. The action can be an action type that describes an action performed on the object 100 by the hand or hand such as the throwing the object, pushing the object 100, the twisting or rotating the object 100, or transferring the object 100 to an opposite hand of the person, as non-limiting examples.

The object trajectory synthesis stage 204 can determine the trajectory of the object 100 by applying a model (e.g., a generative model). The model can, for example, receive the inputs 202 and determine the trajectory of the object 100. The model can determine locations and/or orientations of the object along multiple points of a path based on the inputs 202.

In some implementations, the generative model can include a denoising diffusion model such as a denoising diffusion probabilistic model forward diffusion process that applies, for example, a Markov process to the action and mass of the object 100 with gaussian noise (the action, mass, and gaussian noise are received as inputs 202). In some implementations, the inputs 202 also include a shape of the object 100. The noise can be added at multiple (T) steps. The object trajectory synthesis stage 204 can denoise the animation during a corresponding number (T) steps. The determination and/or generation of the trajectory of the object 100 can include generating an animation of the object 100.

The hand motion synthesis stage 210 can determine a motion of the hand 104 (or hands) based on the trajectory of the object 100 (or animation of the object 100) determined by the object trajectory synthesis stage 204. The hand motion synthesis stage 210 can determine the motion of the hand 104 based on the trajectory of the object 100 as well as inputs 212 that are independent of the trajectory of the object 100. The inputs 212 can include, for example, an action and/or action type performed on the object 100, a mass of the object, random noise (distinct from the noise included in the inputs 202), and/or a description of the object 100 such as a shape of the object 100.

The inputs 212 can include the action type that describes an action performed by the hand 104 on the object 100, such as throwing the object, pushing the object 100, the twisting or rotating the object 100, or transferring the object 100 to an opposite hand of the person, as non-limiting examples.

The inputs 212 can include a mass of the object 100. The hand motion synthesis stage 210 can change a number of contact points between the hand 104 and the object 100 based on the mass of the object 100. A greater mass of the object 100 can result in more contact points between the hand 104 and the object 100 because a greater mass requires a hand to grip an object more tightly.

The inputs 212 can include noise. The noise can include random noise that causes the generation and/or determination of the motion of the hand 104 by the hand motion synthesis stage 210 to be non-deterministic, with different generations of motions of the hand 104 by the hand motion synthesis stage 210 to result in different motions and/or animations.

The inputs 212 can include a shape or other description of the object 100. The shape can include, for example, a sphere, a cone, a shape of an animal, or a prism, as non-limiting examples. The hand motion synthesis stage 210 can determine who the hand 104 holds and/or grips the object 100 based on the shape of the object 100.

The hand motion synthesis stage 210 can determine and/or generate the motion of the hand 104 by applying a diffusion model such as a denoising diffusion model. The denoising diffusion model can remove the noise included in the inputs 212 to create a clear, realistic-appearing animation of the hand 104. The denoising diffusion model can, for example, smooth the movement of the hand 104 to eliminate jerky movements.

The hand motion synthesis stage 210 can perform fitting of the motion of the hand 104 to the trajectory of the object 100. The fitting can identify (e.g., determine, optimize) a fit between the trajectory of the object 100 and the motion of the hand 104. The determination (e.g., optimization) can include generating and applying probabilities of contacts by portions of the hand 104 to the object, causing the hand 104 to be near and/or around the object 100 rather than inside or too far from the object 100. The fitting can determine contacts between the hand 104 and the object 100.

In some implementations, determining contacts between the hand 104 and the object 100 can include applying a probabilistic model to each possible point of contact between the hand 104 and object 100. The probabilistic model can include a probability of contact for each possible point of contact between the hand 104 and object 100, with the probability of contact being a function of the mass of the object 100, the probability increasing with greater mass.

The system 200 introduced in FIG. 2A is described in greater detail below in connection with FIG. 2B. Further details of some implementations of the object trajectory synthesis stage 204 and hand motion synthesis stage 210 are provided, as well as details about modeling the hand 104.

In some implementations, the hand 104 is modeled as a nonlinear parametric model learned from large-scale three-dimensional human scans. The hand model (or model of the hand 104) can define a three-dimensional hand mesh as a differentiable function M(τ, ϕ, θ, β) of global root translation T∈ [symbol] , global root orientation ϕ∈ [symbol] represented in six-dimensional rotation representation, pose parameters θ∈ [symbol] and shape parameters β∈ [symbol] . The shape parameters can describe widths and lengths of the fingers and phalanges included therein and/or locations of joints in the fingers. A first such hand model can represent the left hand and a second such hand model can represent the right hand, which return hand vertices ν∈ [symbol] (in an example l=1882=941·2) and three-dimensional hand joints j∈ [symbol] (K=42=21·2). A pose of the object 100 can be represented by a three-dimensional translation τ_{obj}. ∈ [symbol] and rotation ϕ_{obj}. ∈ [symbol] . In some implementations, the system 200 synthesizes N successive three-dimensional hand motions represented by the hand vertices V={ν₁, . . . , ν_{N}}∈ [symbol] and hand joints J={j₁, . . . j_{N}}∈ [symbol] . In some examples, the system synthesizes N successive poses of the object:

$$Φ = \{ {Φ}_{1} , … , {Φ}_{N} \} ∈ {ℝ}^{N \times ( 3 + 6 )} , \qquad ( 1 )$$

where Φᵢ=[τ_{obj,i}, ϕ_{obj,i}]. The pose of the object 100 can be defined in a fixed world frame [symbol] Global hand translations can be represented relative to a center position of the object. The global hand rotations can be represented relative to [symbol] .

The system 200 can receive the inputs 202. The inputs 202 can include noise, an action and/or action type, and a mass of the object. The noise can include randomly generated values that cause different iterations (or generations of animations) with the same action and mass of the object to generate different animations. In some implementations, the noise is gaussian noise sampled from a range between zero (0) and one (1).

The system 200 can apply a generative model. In some implementations, the generative model can generate an animation and/or trajectory of the object 100 with the mass of the object 100 and/or an action type of the hand as inputs to the generative model. In some implementations, the generative model can generate an animation of the hand 104 with the mass of the object 100 and the trajectory of the object 100 as inputs to the generative model.

In some implementations, the generative model includes a denoising diffusion model. In some implementations, the denoising diffusion model is a denoising diffusion probabilistic model forward diffusion process that applies a Markov process and adds gaussian noise. The noise included in the inputs 202 can be added at T steps. In an implementation in which X⁽⁰⁾ is the original ground-truth (GT) data without noise, the forward diffusion process can be defined by a distribution q(·):

$$q ( {X}^{( 1 : T )} \vert {X}^{( 0 )} ) = {\prod }_{t = 1}^{T} q ( {X}^{( t )} \vert {X}^{( t - 1 )} ) , \qquad ( 2 )$$

$$q ( {X}^{( t )} \vert {X}^{( t - 1 )} ) = 𝒩 ( {X}^{( t )} \vert \sqrt{1 - {β}_{t}} {X}^{( t - 1 )} , {β}_{t} I ) , \qquad ( 3 )$$

where βₜ are constant hyperparameters (scalars) that are fixed per each diffusion time step t. Using a reparameterization technique, the system 200 can sample X^{(t)} using the original data X⁽⁰⁾ and standard Gaussian noise ϵ˜ [symbol] (0, I):

$${X}^{( t )} = \sqrt{{α}_{t}} {X}^{( 0 )} + \sqrt{1 - {α}_{t}} ϵ , \qquad ( 4 )$$

where αₜ=Πᵢ₌₁^{t}(1−βᵢ). The system 200 can be trained to reverse this process by denoising on each diffusion time step starting from a standard normal distribution X^{(T)}˜ [symbol] (0, I):

$$p ( {X}^{( 0 : T )} ) = p ( {X}^{( T )} ) {\prod }_{t = 1}^{T} p ( {X}^{( t - 1 )} \vert {X}^{( t )} ) , \qquad ( 5 )$$

where p(X^{(t-1)}|X) denotes the conditional probability distribution estimated from the network output. From Eq. (5), the system 200 obtains the meaningful generated result X* after T times of denoising process.

The system 200 can predict the added noises on the data for a reverse diffusion process. The loss term can be formulated as

$${ℒ}_{simple} = {E}_{ϵ , t \sim [ 1 , T ]} [ {‖ ϵ - {ϵ}_{θ} ( {X}^{( t )} , t , c ) ‖}_{2}^{2} ] , \qquad ( 6 )$$

where c denotes an optional conditioning vector. The loss term of Eq. (6) can drive the system 200 ϵ_{θ} towards predicting the added noise. Training the system 200 with Eq. (6) can generate diverse motions.

X*can represent sequences of three-dimensional points corresponding to the synthesized motion trajectories (for hands and objects). However, Eq. (6) can lead to artefacts in the generated sequences such as joint jitters and varying bone length when applied to motion synthesis. To improve the plausibility of the generated results, the system 200 can integrate the explicit geometric loss terms into the training of denoising diffusion probabilistic model. At an arbitrary diffusion time step t, the system 200 can obtain the approximated original data \hat{X}⁽⁰⁾ using the estimated noise from Ee instead of E in Eq. (4) and solving for \hat{X}⁽⁰⁾.

$${\hat{X}}^{( 0 )} = \frac{1}{\sqrt{α}} {X}^{( t )} - ( \sqrt{\frac{1}{α} - 1} ) {ϵ}_{θ} ( {X}^{( t )} , t , c ) . \qquad ( 7 )$$

Geometric penalties can be applied on \hat{X}⁽⁰⁾ to prevent the aforementioned artefacts. The approximated set of hand joints obtained from Eq. (7) can be denoted Ĵ⁽⁰⁾. The approximated set of poses of the object obtained from Eq. (7) can be denoted \hat{Φ}⁽⁰⁾. The synthesized set of hand joints obtained from the reverse diffusion process of Eq. (5) can be denoted J*. The synthesized set of poses of the object obtained from the reverse diffusion process Eq. (5) can be denoted Φ*.

The inputs 202 can include an action. The action can include an action label, action type, and/or action description. The action can describe the action and/or interaction between the hand 104 (shown in FIG. 1) and the object 100 (shown in FIG. 1). The action can include, for example, the hand 104 throwing the object 100, the hand 104 pushing the object 100, the hand 104 twisting or rotating the object 100, or the hand 104 transferring the object 100 to an opposite hand of the person, as non-limiting examples.

The inputs 202 can include a mass. The mass can include a mass of the object 100. The inputs 202 can also include a shape of the object 100. The mass of the object 100 can be associated with the shape of the object 100. The shape of the object can include, for example, a sphere, a cone, a shape of an animal, or a prism, as non-limiting examples. The mass of the object 100 can include a mass and/or weight. The mass of the object 100 can be measured in metric units, such as in grams or kilograms, or in standard units, such as pounds and ounces. The shape of the object 100 can also include dimensions in metric units such as meters or millimeters or standard units such as feet and inches.

In some examples, the object 100 is represented as a mesh. The mesh can represent the shape of the object 100. The mesh can include polygonal patches such as triangular patches. The vertices of the mesh elements or patches can be considered node points that track motion of the object 100.

The system 200 can include an object trajectory synthesis stage 204. The object trajectory synthesis stage 204 can generate, determine, and/or output a trajectory of the object 100. The object trajectory synthesis stage 204 can generate the trajectory of the object 100 based on the inputs 202. The object trajectory synthesis stage 204 can generate the trajectory of the object 100 based on the noise, action performed by the hand 104, and/or mass of the object 100. The trajectory determined by the object trajectory synthesis stage 204 can have similar features as the trajectory 102 described above with respect to FIG. 1.

The object trajectory synthesis stage 204 can include one or multiple diffusion layers 206. The diffusion layers 206 can comprise a cascaded diffusion model that performs diffusion on the output of preceding diffusion layers. In some implementations, the diffusion layers 206 include two sets of residual blocks of one-dimensional convolutional layers. A number of kernels at an output convolutional layer of the diffusion layers 206 can be set to correspond to a dimensionality of a pose of the object 100, such as twenty-one (21) kernels. The diffusion layers 206 can generate the trajectory of the object 100 by applying a diffusion model. The diffusion layers 206 can apply, for example, a denoising diffusion model to generate the trajectory of the object 100. In some implementations, the diffusion layers 206 include and/or implement a trajectory denoising diffusion model to generate the trajectory of the object 100. The trajectory denoising diffusion model can be based on a stable diffusion architecture with one-dimensional convolutional layers and two-dimensional convolutional layers. Geometric penalties on Ĵ⁽⁰⁾∈ [symbol] and \hat{Φ}⁽⁰⁾∈ [symbol] can be combined with the simple loss described in Eq. (6).

The diffusion layers 206 can include and/or implement a diffusion model-based architecture hat synthesizes an object trajectory given a mass value m and an action type a where a ∈ [symbol] , wherein the action type a can be encoded as a one-hot vector. The action type can represent an action performed by the hand on the object, such as grabbing, throwing, pushing, holding, or rotating.

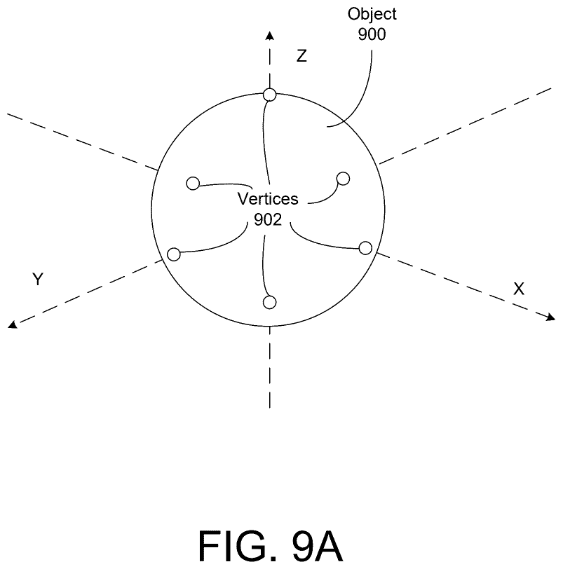

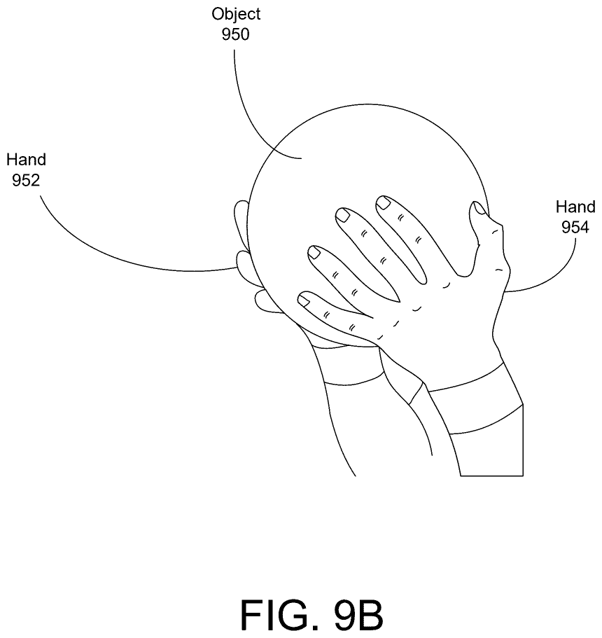

In some implementations, directly synthesizing a set of object rotation values can cause jitter artefacts. The jitter artefacts may be caused by simultaneously and/or concurrently synthesizing two aspects of a pose, translation and rotation, each having a different representation. To remedy the jitter artefacts, the object trajectory synthesis stage 204 can represent both the translation and rotation as three-dimensional coordinates in a Cartesian coordinate system. The object trajectory synthesis stage 204 can first synthesize reference vertex positions P_{ref} on a surface of the object defined in a reference frame of the object, and register them to predefined template vertex positions Pₜₑₘₚ to obtain the rotation of the object. Six template vertices are defined as shown in FIG. 9A. The diffusion layers 206 can synthesizes a set of reference vertex positions P_{ref}∈ [symbol] where, in some implementations, q=18(=6×3) that are defined in the object center frame along with a set of global translations. The object trajectory synthesis stage 204 can then apply Procrustes alignment between P_{ref} and Pₜₑₘₚ to obtain the object rotations. The objective of the diffusion layers 206 can be defined as follows:

$${ℒ}_{𝒯} = {ℒ}_{simple} + {λ}_{geo .} ( {λ}_{rec .} {ℒ}_{rec .} + {λ}_{vel .} {ℒ}_{vel .} + {λ}_{acc .} {ℒ}_{acc .} + {λ}_{ref .} {ℒ}_{ref .} ) . \qquad ( 20 )$$

[symbol] , [symbol] and [symbol] follow the definitions given in Eqs. (11), (12) and (13), where J⁽⁰⁾ is replaced with three-dimensional object poses whose rotation is represented by the reference vertex positions instead of six-dimensional rotation. [symbol] is defined as:

$${ℒ}_{ref} = {‖ {\hat{P}}_{ref}^{( 0 )} - {P}_{ref}^{( 0 )} ‖}_{2}^{2} + {‖ {d}_{rel} ( {\hat{P}}_{ref}^{( 0 )} ) - {d}_{rel} ( {P}_{ref}^{( 0 )} ) ‖}_{2}^{2} . \qquad ( 21 )$$

The first term of [symbol] penalizes Euclidean distances between the approximated reference vertex positions \hat{P}_{ref}⁽⁰⁾ of Eq. (7) and the reference vertex positions P_{ref}⁽⁰⁾. The second term of [symbol] penalizes the incorrect Euclidean distances of the approximated reference vertex positions relative to each other. The object trajectory synthesis stage 204 can apply a function [symbol] → [symbol] , where

$${q}^{′} = ( \begin{matrix}q \\ 2\end{matrix} ) ,$$

which computes and/or determines distances between the input vertices pairs on each frame.

The generated object trajectory responds to the specified masses. For example, the motion range and the velocity of the object tend to be larger for smaller masses. With a heavier object the trajectory shows slower motion and a more regulated motion range.

Generating the trajectory of the object 100 can include generating an animation of the object 100. The object trajectory synthesis stage 204 can generate an object trajectory output 208. The object trajectory output 208 can include the trajectory and/or animation of the object 100 generated, determined, and/or outputted by the object trajectory synthesis stage 204.

The system 200 can include a hand motion synthesis stage 210. The hand motion synthesis stage 210 can generate, determine, and/or output motion of the hand 104. The hand motion synthesis stage 210 can generate, determine, and/or output motion of the hand 104 based on the object trajectory output 208 and based on inputs 212.

The inputs 212 received by the hand motion synthesis stage 210 can include the same action and mass values as the inputs 202, a noise value generated independently of the noise value included in the inputs 202, and a description of the object 100. The noise value can include a randomly generated value with a gaussian distribution between zero (0) and one (1). The description of the object 100 can include a description of the shape of the object (such as spherical, conical, animal-shaped, or prism-shaped, as non-limiting examples) and/or a distribution of mass through the object. In some implementations the mass is evenly distributed throughout the object 100. In some implementations the mass is more heavily distributed in some portions of the object 100 than other portions of the object 100. In some implementations, the mass of the object 100 is represented as a scalar which does not represent a location of a center of mass of the object 100.

The hand motion synthesis stage 210 can include one or multiple diffusion layers 214. The diffusion layers 214 can comprise a cascaded diffusion model that performs diffusion on the output of a preceding diffusion layer. In some implementations, the diffusion layers 214 include four sets of two-dimensional convolutional residual blocks for encoder and decoder architecture.

The diffusion layers 214 receive as input the object trajectory output 208 and the action and mass and noise from the inputs 212. The diffusion layers 214 can generate the motion of the hand 104 by applying a diffusion model. The diffusion layers 214 can apply, for example, a denoising diffusion model to generate the motion of the hand 104. In some implementations, the diffusion layers 214 include and/or implement a hand denoising diffusion model to generate the motion of the hand 104. The hand denoising diffusion model can be based on a stable diffusion architecture with one-dimensional convolutional layers and two-dimensional convolutional layers. Geometric penalties on Ĵ⁽⁰⁾∈ [symbol] and \hat{Φ}⁽⁰⁾∈ [symbol] can be combined with the simple loss described in Eq. (6). Generating the motion of the hand 104 can include generating an animation of the hand 104.

The hand motion synthesis stage 210 can synthesize a set of three-dimensional hand joints and per-vertex hand contact probabilities. The vertices can be vertices of the hand, such as joints within fingers and/or joints connecting the fingers to the palm. The per-vertex hand contact probabilities can be a function of the mass of the object, with the probability of contact at each vertex increasing as the mass increases. Determining and/or storing contact positions of hands reduces unnatural-looking floating object artefacts of the object manipulation (or hands interacting with the object).

The diffusion layers 214 can receive as inputs a three-dimensional trajectory Φ∈ [symbol] and mass scalar value m where N is the number of frames of the sequence. From a reverse diffusion process of [symbol] (·), the diffusion layers 214 can obtain the synthesized set of three-dimensional joints J*∈ [symbol] . The diffusion layers 214 can synthesize Φ by either TrajDiff [symbol] (·) or based on manual input received from a user or administrator.

The hand motion synthesis stage 210 can include a network 216 such as a neural network. The network 216 can include a convolutional neural network. The network 216 can be a one-dimensional convolutional neural network. The network 216 can include, for example, three one-dimensional convolutional layers with exponential linear units (ELUs) and a sigmoid activation for hidden layers and an output layer, respectively. The network 216 can generate motion of the hand 104 based on the object trajectory output 208 and the action and mass of the object included in the inputs 212.

Along with the set of three-dimensional hand joint positions, the network 216 can estimate the contact probabilities b∈ [symbol] on the hand vertices from the hand joint and pose sequence of the object with a conditioning vector c that consists of a mass value m and an action type or label a.

The network 216 can be trained using a binary cross entropy (BCE) loss with the ground truth hand contact labels l_{con}.

$${ℒ}_{con .} = BCE ( f ( {J}^{( 0 )} , {Φ}^{( 0 )} , c ) , {l}_{con .} ) , \qquad ( 8 )$$

where J⁽⁰⁾ and Φ⁽⁰⁾ denote a set of ground truth three-dimensional hand joints and ground truth object poses, respectively. The network 216 can estimate the contact probabilities from the synthesized three-dimensional hand joints and object positions conditioned on c. A fitting optimization stage 218 (described below) can use estimated contact probabilities b in fitting optimization to increase the plausibility of the hand and object interactions.

The diffusion layers 214 can have an objective [symbol] for training, which can be defined as follows:

$${ℒ}_{H} = {ℒ}_{simple} + {λ}_{geo} + {ℒ}_{geo} , \qquad ( 9 )$$

where [symbol] simple is computed following Eq. (6) and

$${ℒ}_{geo} - {λ}_{rec} . {ℒ}_{rec} . + {λ}_{vel} . {ℒ}_{vel} . + {λ}_{acc} {ℒ}_{acc} . + {λ}_{blen} {ℒ}_{blen} . \qquad ( 10 )$$

[symbol]

, [symbol] and [symbol] can be loss terms to penalize the positions, velocities and accelerations of the synthesized hand joints, respectively:

$${ℒ}_{rec .} = {‖ {\hat{J}}^{( 0 )} - {J}^{0} ‖}_{2}^{2} , \qquad ( 11 )$$

$${ℒ}_{vel .} = {‖ {\hat{J}}_{vel .}^{( 0 )} - {J}_{vel .}^{( 0 )} ‖}_{2}^{2} , \qquad ( 12 )$$

$${ℒ}_{acc .} = {‖ {\hat{J}}_{acc .}^{( 0 )} - {J}_{acc .}^{( 0 )} ‖}_{2}^{2} , \qquad ( 13 )$$

where Ĵ⁽⁰⁾ is an approximated set of hand joints from Eq. (7) and J denotes a set of ground truth hand joints. Ĵ⁽⁰⁾ and J⁽⁰⁾ with the subscript “vel.” and “acc.” represent the velocities and accelerations computed from their positions, respectively.

A value [symbol] can penalize incorrect bone lengths of the hand joints using a function d_{blen}: [symbol] → [symbol] , that computes bone lengths of hands given a sequence three-dimensional hand joints of N frames:

$${ℒ}_{blen .} = {‖ {d}_{blen} ( {\hat{J}}^{( 0 )} ) - {d}_{blen} ( {J}^{( 0 )} ) ‖}_{2}^{2} . \qquad ( 14 )$$

The system can obtain a set of three-dimensional hand joints J* using the denoising process detailed in Eq. (5) given a Gaussian noise ˜N(0, I), and a set of per-vertex contact labels.

The hand motion synthesis stage 210 can include a fitting optimization stage 218. A technical problem with synthesizing animations of a hand and an object, which can include three-dimensional hand-object interaction, is that small errors, such as errors of even a few millimeters, can cause collisions or floating-object artefacts that convey an unnatural impression to the viewer. A technical solution to this technical problem is to optimize a fit between the hand and the object.

The fitting optimization stage 218 can optimize the fit between the trajectory of the object 100 and the motion of the hand 104 to generate realistic interactions between the hand 104 and the object 100. The fitting optimization stage 218 can optimize the fit between the trajectory of the object 100 and the motion of the hand 104 based on the object trajectory output 208, the motion of the hand 104 generated by the network 216, the motion of the hand 104 generated by the diffusion layers 214, and the description of the object 100 included in the inputs 212. The fitting optimization stage 218 can optimize the fit between the trajectory of the object 100 and the motion of the hand 104 based on synthesized three-dimensional hand joints and contact information between the hands and the object. The optimization of the fit between the trajectory of the object 100 and the motion of the hand 104 causes the interactions between the hand 104 and the object 100 to appear natural.

After the hand motion synthesis stage 210 (such as the diffusion layers 214) synthesizes the three-dimensional hand joint sequence J* from the trained [symbol] , the fitting optimization stage 218 solves an optimization problem to fit hand models to J*. The fitting optimization stage 218 applies thresholding on the per-vertex contact probability estimated by the network 216 with b>0.5 to select the effective contacts for the fitting optimization. The subset of hand vertex indices with effective contacts on the n-th frame ca be b_{idx}ⁿ⊂ [symbol] 1, L [symbol] . The objectives of the fitting optimization stage 218 can be as follows:

$${argmin}_{τ , ϕ , θ} ( {λ}_{data} {ℒ}_{data} + {λ}_{touch} {ℒ}_{touch} + {λ}_{col .} {ℒ}_{col .} + {λ}_{prior} {ℒ}_{prior} ) . \qquad ( 15 )$$

[symbol]

can be a data term to minimize the Euclidean distances between the hand joint key points J and the synthesized hand key points J*

$${ℒ}_{data} = {‖ J - {J}^{*} ‖}_{2}^{2} \qquad ( 16 )$$

[symbol] includes two terms. Hand keypoints may have been previously obtained from images captured by cameras. The first term reduces the distances between the contact hand vertices and their nearest vertices P on the object to improve the plausibility of the interactions. The second term takes into account the normal vectors of the object and hands, which enhances the natural appearance of the grasp by minimizing the cosine similarity s(·) between the normal vectors of the contact hand vertices n and the normal vectors of their nearest vertices of the object \hat{n}.

$${ℒ}_{touch} = {\sum }_{i = 1}^{N} {\sum }_{j ∈ {b}_{idx}^{i}} {‖ {V}_{i}^{j} - {P}_{i}^{j} ‖}_{2}^{2} + {\sum }_{i = 1}^{N} {\sum }_{i ∈ {b}_{idx}} ( 1 - s ( {n}_{i}^{j} , {\hat{n}}_{i}^{j} ) ) , \qquad ( 17 )$$

where the subscript i denotes i-th frame in the sequence and the superscript j denotes the index of the vertex with the effective contact.

[symbol] reduces collisions between the hand and object by minimizing penetration distances. Let Pⁿ⊂ [symbol] 1, U [symbol] be the subset of hand vertex indices with collisions on n-th frame. Then the fitting optimization stage 218 defines

$${ℒ}_{col .} = {\sum }_{i = 1}^{N} {\sum }_{j ∈ {𝒫}^{n}} {‖ {V}_{i}^{j} - {P}_{i}^{j} ‖}_{2}^{2} . \qquad ( 18 )$$

[symbol] prior is a hand pose prior term that encourages the plausibility of the hand pose by minimizing the pose vector θ of the generative human (GHUM) parametric model

$${ℒ}_{prior} = {‖ θ ‖}_{2}^{2} . \qquad ( 19 )$$

With loss terms combined, the output of the fitting optimization stage 218 shows a plausible hand and object interaction sequence. For non-spherical objects, the fitting optimization stage 218 can apply a gaussian smoothing on the hand and object vertices along the temporal direction with a sigma value of three (3) after the fitting optimization to generate a smooth motion.

The hand motion synthesis stage 210 can generate an animation of hand and object motions 220. The hand and object motions 220 can be an output of the fitting optimization stage 218. The hand and object motions 220 can include the interactions of the hand 104 with the object 100, which includes the trajectory of the object 100 and the motion of the hand 104. The hand and object motions 220 can be represented as N successive pairs of three-dimensional hand poses and object poses.

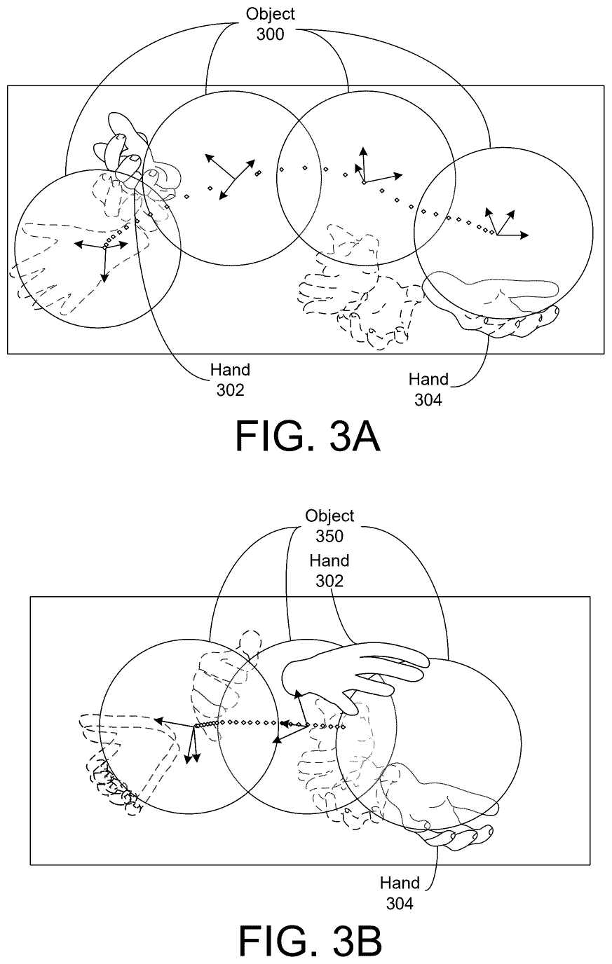

FIGS. 3A through 6B show animations of hands interacting with objects. FIGS. 3A, 4A, 5A, and 6A show animations of hands interacting with objects that have a relatively low mass, and FIGS. 3B, 4B, 5B, and 6B show animations of hands interacting with objects that have relatively high mass. Examples of mass of the relatively low mass of the objects shown in FIGS. 3A, 4A, 5A, and 6A are 0.2 kilograms or 200 grams. Examples of mass of the relatively high mass of the objects shown in FIGS. 3B, 4B, 5B, and 6B are five (5) kilograms. A number of contact points between the hands and objects can be a function of the mass of the object. Objects with greater mass can have more contact points with the hands than objects with lower mass.

FIG. 3A shows a right hand 302 and left hand 304 interacting with a relatively light spherical object 300. The right hand 302 transfers the relatively light spherical object 300 to the left hand 304. Because the relatively light spherical object 300 is relatively light, the relatively light spherical object 300 can be held by one of the right hand 302 or the left hand 304 at a time.

FIG. 3B shows the right hand 302 and left hand 304 interacting with a relatively heavy spherical object 350. The right hand 302 and left hand 304 rotate the relatively heavy spherical object 300. Because the relatively heavy spherical object 350 is relatively heavy, the relatively heavy spherical object 350 is held by both of the right hand 302 and the left hand 304 at the same time.

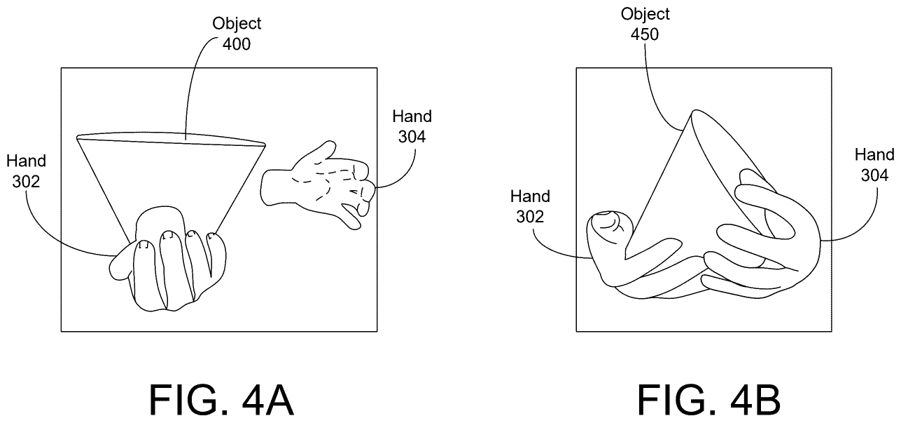

FIG. 4A shows the right hand 302 interacting with a relatively light conical object 400. The right hand 302 holds the relatively light conical object 400 in a palm of the right hand 302. Because the relatively light conical object 400 is relatively light, the right hand 302 can hold the relatively light conical object 400 without assistance from the left hand 304. Because the relatively light conical object 400 is relatively light, the right hand 302 can hold the relatively light conical object 400 with the palm of the right hand 302 and fingertips of the right hand 302 as contact points with the relatively light conical object 400.

FIG. 4B shows the right hand 302 and left hand 304 interacting with a relatively heavy conical object 450. Because the relatively heavy conical object 450 is relatively heavy, both the right hand 302 and the left hand 304 are needed to hold the relatively heavy conical object 450. Because the relatively heavy conical object 450 is relatively heavy, the right hand 302 and the left hand 304 hold the relatively heavy conical object 450 with a relatively high number of contact points along the palms and fingers of the right hand 302 and the left hand 304.

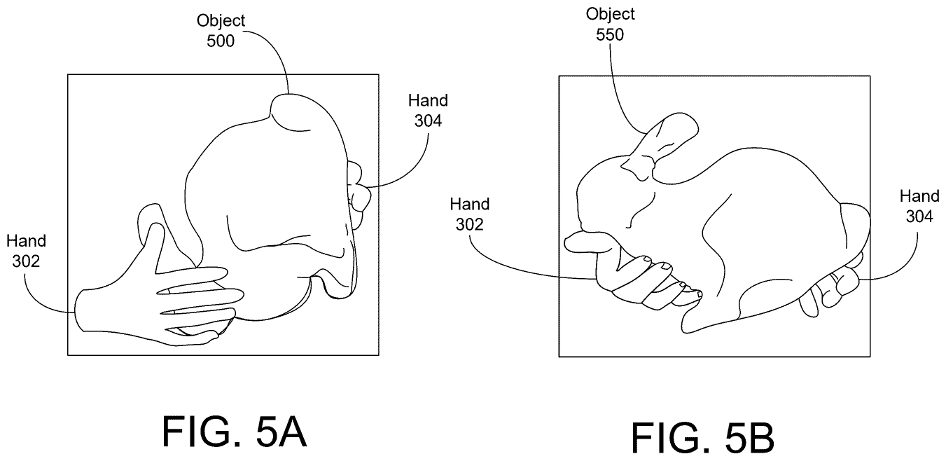

FIG. 5A shows the right hand 302 and the left hand 304 holding a relatively light animal-shaped object 500. Because the relatively light animal-shaped object 500 is relatively light, the right hand 302 and left hand 304 can hold the relatively light animal-shaped object 500 with relatively few contact points, such as at the fingertips of the right hand 302 and fingertips of the left hand 304.

FIG. 5B shows the right hand 302 and the left hand 304 holding a relatively heavy animal-shaped object 550. Because the relatively heavy animal-shaped object 550 is relatively heavy, both the right hand 302 and left hand 304 are needed to hold the relatively heavy animal-shaped object 550. Because the relatively heavy animal-shaped object 550 is relatively heavy, the right hand 302 and left hand 304 hold the relatively heavy animal-shaped object 550 with a relatively high number of contact points, such as along palms and inside portions of fingers of the right hand 302 and left hand 304.

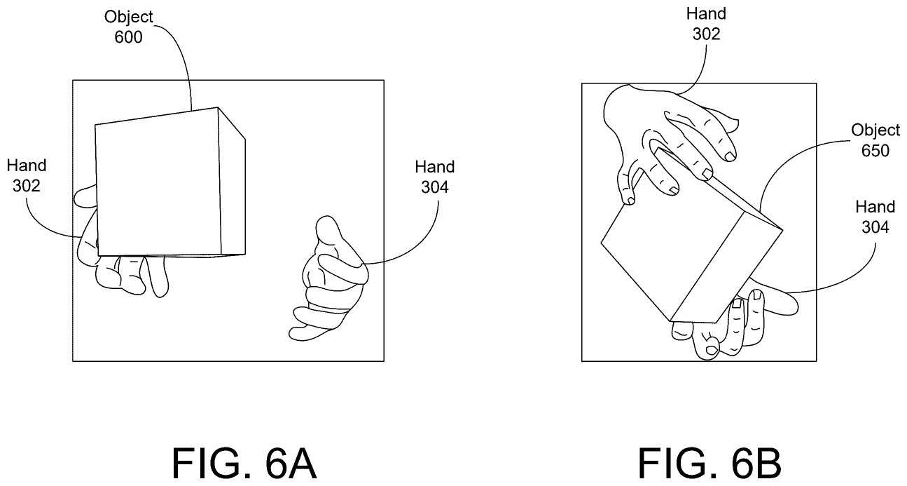

FIG. 6A shows the right hand 302 holding a relatively light cuboid object 600. Because the relatively light cuboid object 600 is relatively light, the right hand 302 can hold the relatively light cuboid object 600 without assistance from the left hand 304. Because the relatively light cuboid object 600 is relatively light, the right hand 302 can hold the relatively light cuboid object 600 with relatively few contact points, such as at fingertips of the right hand 302.

FIG. 6B shows the right hand 302 and left hand 304 holding a relatively heavy cuboid object 650. Because the relatively heavy cuboid object 650 is relatively heavy, both the right hand 302 and the left hand 304 are needed to hold the relatively heavy cuboid object 650. Because the relatively heavy cuboid object 650 is relatively heavy, both the right hand 302 and the left hand 304 hold the relatively heavy cuboid object 650 with a relatively high number of contact points, such as along inside portions of fingers of the right hand 302 and left hand 304.

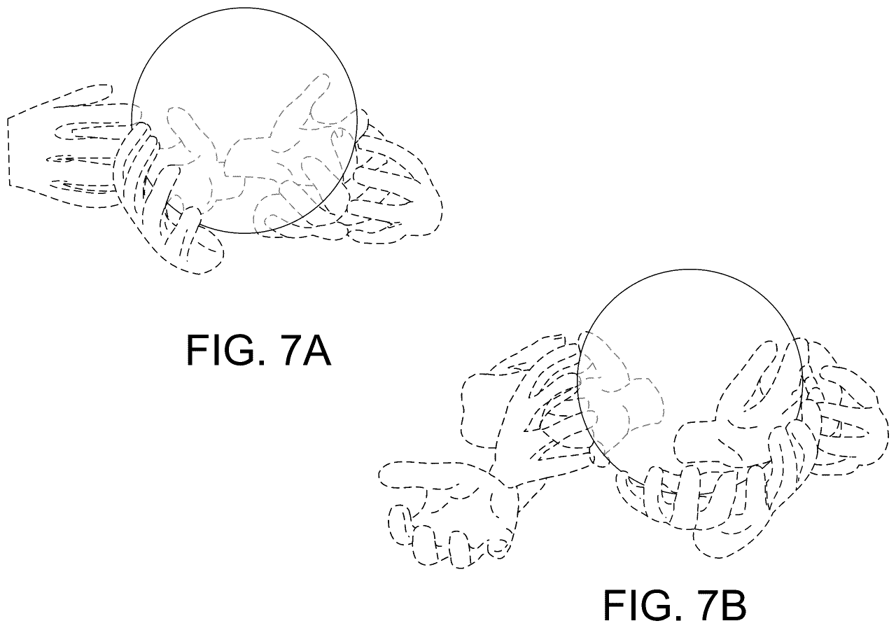

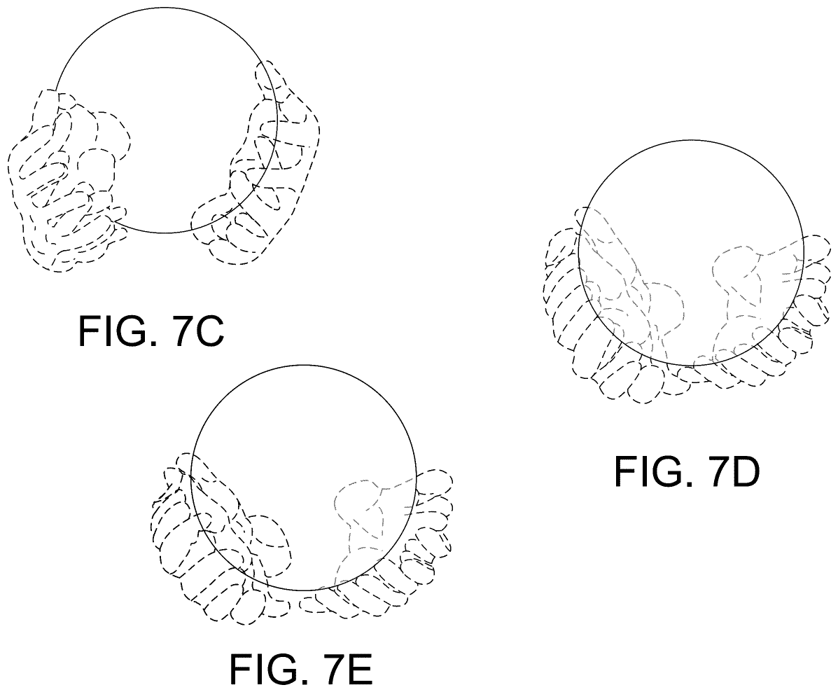

FIGS. 7A through 7E show hands holding spherical objects with sequentially greater masses. In an implementation, the object of FIG. 7A has a mass of 0.05 kilograms or 50 grams, the object of FIG. 7B has a mass of 0.175 kilograms or 175 grams, the object of FIG. 7C has a mass of 2.5 kilograms, the object of FIG. 7D has a mass of 4.9 kilograms, and the object of FIG. 7E has a mass of 10.0 kilograms. As shown in FIGS. 7A through 7E, as the mass of the object increases, the number of contact points between the hands and the object increases. When the object has a lower or smaller mass, such as in FIGS. 7A and 7B, the hands can hold the object with mere fingertips and can even release the object for some time, and the hands are generally more mobile. With objects of higher or greater mass, a larger area of the hands, and/or a greater number of contact points, is needed to hold and/or control the object, and the hands are less mobile.

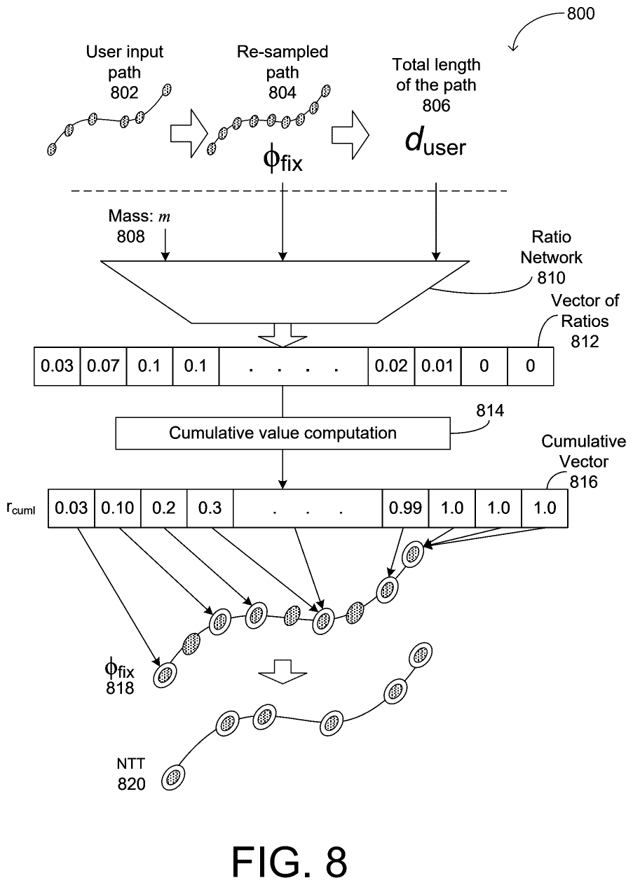

FIG. 8 shows a user input trajectory processing stage 800. The user input trajectory processing stage 800 can generate the trajectory of the object. The user input trajectory processing stage 800 can perform functions of the object trajectory synthesis stage 204.

A user can be given control over the trajectory of the object for downstream applications such as character animations or avatar communications. A manually-drawn and/or user-supplied object trajectory can be provided to the system, such as the system 200, as input. The system 200 can synthesize three-dimensional hand motions and hand contacts from a mass value of the object and a trajectory of the object. The user input trajectory processing stage 800 can account for the slower acceleration and/or deceleration of heavier objects than lighter objects. The user input trajectory processing stage 800 can receive a user-specified trajectory with an arbitrary number of points along a path and the mass of the object and output a normalized target trajectory (NTT) 820. The user input trajectory processing stage 800 can provide the NTT path 820 to the object trajectory output 208 and/or hand motion synthesis stage 210 for generation of hand and object interaction motions.

The user input trajectory processing stage 800 includes a user input path 802. The user input path 802 includes locations of an object that were inputted manually by a user. The user input path 802 can be a received path.

The user input trajectory processing stage 800 generates a re-sampled path 804. The user input trajectory processing stage 800 generates the re-sampled path 804 based on the user input path 802. The user input trajectory processing stage 800 generates the re-sampled path 804 by re-sampling the user input path 802 to a predetermined number of points along the path. The re-sampled path 804 includes locations of the object that are interpolated by a computing system based on the user input path 802. The user input trajectory processing stage 800 can interpolate the user-provided trajectory of Nᵤₛₑᵣ points (user input path 802) into a path Φ_{fix} (re-sampled path 804) of length N_{fix} points (re-sampled path 804). The user input trajectory processing stage 800 also determines a total path length dᵤₛₑᵣ (total length of the path 806) that is one of the inputs to a ratio network stage 810:

$${d}_{user} = {\sum }_{i = 1}^{{N}_{fix} - 1} {‖ {Φ}_{fix}^{i} - {Φ}_{fix}^{i + 1} ‖}^{2} , \qquad ( 22 )$$

where Φ_{fix}ⁱ denotes the i-th object position in Φ_{fix}.

The user input trajectory processing stage 800 determines a total length of the path 806. The user input trajectory processing stage 800 determines the total length of the path 806 based on the user input path 802. The total length of the path 806 is a length of distance traveled by the object based on the re-sampled path 804. The user input trajectory processing stage 800 provides the re-sampled path 804 and the total length of the path 806 to the ratio network stage 810.

The user input trajectory processing stage 800 includes a ratio network stage 810. The ratio network stage 810 can be a multilayer perceptron (MLP)-based network that normalizes distances traveled by the object along the re-sampled path 804. In some implementations, the ratio network stage 810 includes a three-layer MLP with exponential linear units (ELUs) and a sigmoid activation function in hidden and output layers, respectively. The ratio network stage 810 can normalize the distances traveled by the object along the re-sampled path 804 based on the total length of the path 806. The ratio network stage 810 can normalize the distances traveled by the object along the re-sampled path 804 to values that add up to a total of one (1). The ratio network stage 810 can normalize the distances traveled by the object along the re-sampled path 804 to values that add up to a total of one (1) based on the re-sampled path 804, the total length of the path 806, and a mass 808 of the object.

The ratio network stage 810 determines locations of the object at each time step based on the normalized object path Φ_{fix} (re-sampled path 804), a total distance of the path dᵤₛₑᵣ (total length of the path 806), and mass of the object m. The ratio network stage 810 can estimate locations of the object along the path Φ_{fix} (path 818) encoded as a ratio of the total length of the path 806 from the beginning of the re-sampled path 804.

The ratio network stage 810 generates a vector of ratios 812. The vector of ratios 812 is an intermediate representation of the user input path 802 and/or re-sampled path 804. The vector of ratios 812 is a vector with values representing the ratios of distances traveled by the object. The distances included in the ratios 812 are distances from a previous point within the re-sampled path 804. The distances included in the vector of ratios 812 are normalized to a range of between zero (0) and one (1) and indicate proportions and/or percentages of the total distance traveled from the previous point along the path. The values included in the vector of ratios 812 add up to one.

To generate the vector of ratios 812, the ratio network stage 810 can accept a residual of Φ_{fix} (re-sampled path 804) denoted as Φ̅_{fix}, a mass scalar value and dᵤₛₑᵣ (total length of the path 806) and output a vector of ratios 812 r∈ [symbol] that includes the update of the ratios on the path for each time step:

$$r = R ( {Φ}_{fix} , m , {d}_{user} ) . \qquad ( 23 )$$

The input trajectory processing stage includes a cumulative value computation stage 814. The cumulative value computation stage 814 generates a cumulative vector 816. The cumulative value computation stage 814 generates the cumulative vector 816 by adding previous values within the vector of ratios 812 starting at a time step zero (0) to an end of a frame sequence that represents the path of the object. The cumulative vector 816 has the same number of values as the vector of ratios 812. The values included in the cumulative vector 816 represent total distances traveled (normalized to a total distance of one) by the object for each point within the re-sampled path 804.

The values within the cumulative vector 816 map to points within 4)_{f}ix, which can be considered a re-sampled path 818, and which corresponds to the re-sampled path 804. The input trajectory processing stage can map the re-sampled path 818 to an NTT path 820 by generating a normalized target trajectory (NTT), or performing an integer discrete Fourier transform on the re-sampled path 818.

The user input trajectory processing stage 800 can generate the NTT path 820 Φ_{NTT}=[Φ_{NTT}⁰, . . . , Φ_{NTT}^{N}] at time step t as:

$${Φ}_{NTT}^{t} = {Φ}_{fix}^{id} , with id = round ( {r}_{cum}^{t} {N}_{fix} ) , \qquad ( 24 )$$

where id denotes the index of Φ_{fix}.

Ratio network stage 810 can be trained with the following loss function [symbol] :

$${ℒ}_{ratio} = {‖ r - \hat{r} ‖}_{2}^{2} + {‖ {r}_{vel} - {\hat{r}}_{vel} ‖}_{2}^{2} + {‖ {r}_{ac .} - {\hat{r}}_{acc} ‖}_{2}^{2} + {ℒ}_{one} , \qquad ( 25 )$$

$${ℒ}_{one} = {‖ ( {\sum }_{i = 1}^{N} {r}^{i} ) - 1 ‖}_{2}^{2} , \qquad ( 26 )$$

where \hat{r} denotes the ratio updates. In some implementations the terms in Eq. (26) have the same weights. The subscripts “vel.” and “acc.” represent the velocity and accelerations of r and \hat{r}, respectively. [symbol] encourages the ratio network stage 810 to estimate the sum of the ratio updates to be 1.0.

FIG. 9A shows a visualization of template vertices 902 of an object 900. The object 900 is an example of any of the objects 100, 300, 350, 400, 450, 500, 550, 600, 650 described above. FIG. 9A includes six template vertices 902 for the object 900. A system, such a the computing system 1000, synthesizes a set of reference vertex positions P_{ref}∈ [symbol] where q=18(=6×3) that are defined in a center frame of the object 900 along with a set of global translations. The system can then apply Procrustes alignment between P_{ref} and Pₜₑₘₚ to obtain rotations of the object. An objective can be defined as follows:

$${ℒ}_{𝒯} = {ℒ}_{simple} + {λ}_{geo .} ( {λ}_{rec .} {ℒ}_{rec .} + {λ}_{vel .} {ℒ}_{vel .} + {λ}_{acc .} {ℒ}_{acc .} + {λ}_{ref .} {ℒ}_{ref .} ) . \qquad ( 20 )$$

[symbol] , [symbol] and [symbol] follow the definitions given in Eqs. (11), (12) and (13), where J⁽⁰⁾ is replaced with ground truth three-dimensional object poses whose rotation is represented by the reference vertex positions instead of six-dimensional rotation. [symbol] is defined as:

$${ℒ}_{ref} = {‖ {\hat{P}}_{ref}^{( 0 )} - {P}_{ref}^{( 0 )} ‖}_{2}^{2} + {‖ {d}_{rel} ( {\hat{P}}_{ref}^{( 0 )} ) - {d}_{rel} ( {P}_{ref}^{( 0 )} ) ‖}_{2}^{2} . \qquad ( 21 )$$

The first term of [symbol] penalizes the Euclidean distances between the approximated reference vertex positions \hat{P}_{ref}⁽⁰⁾ of Eq. (7) and the ground truth reference vertex positions P_{ref}⁽⁰⁾. The second term of [symbol] penalizes incorrect Euclidean distances of the approximated reference vertex positions relative to each other. To this end the system applies a function [symbol] → [symbol] , where

$${q}^{′} = ( \begin{matrix}q \\ 2\end{matrix} ) ,$$

which computes the distances between all the input vertices pairs on each frame.

The generated object trajectory responds to the specified masses. For instance, the motion range and the velocity of the object tend to be larger for smaller masses. In contrast, with a heavier object the trajectory shows slower motion and a more regulated motion range.

FIG. 9B shows an image of a sphere. The sphere is represented in FIG. 9B as a spherical object 950. The spherical object 950 is held by a right hand 952 and a left hand 954. The image shown in FIG. 9B can be an image within an animation generated as described herein and/or with respect to FIG. 9A.

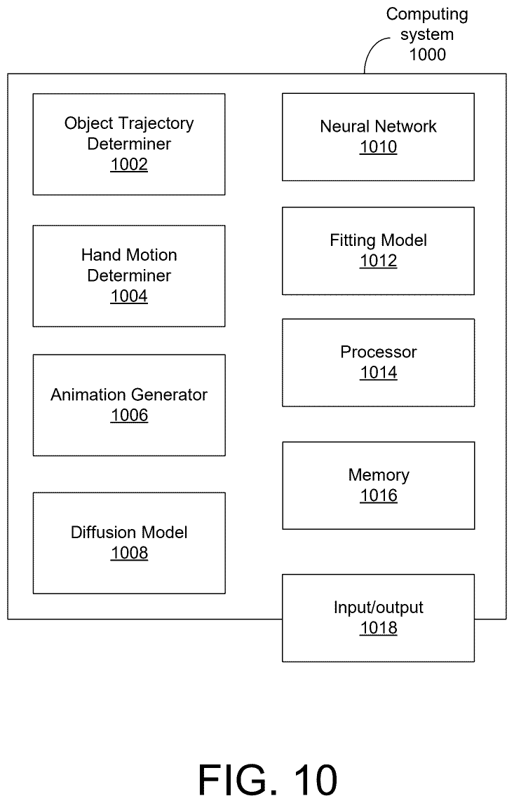

FIG. 10 is a block diagram of a computing system 1000 for generating an animation of a hand interacting with an object based on a mass of the object. The computing system 1000 can represent a single computing device, such as a server, a desktop computer, a laptop computer, a tablet computing device, or a smartphone, or a distributed system in which multiple computing devices perform functions, communicate actions and/or data to each other to generate the animation of the hand interacting with the object.

The computing system 1000 can include an object trajectory determiner 1002. The object trajectory determiner 1002 can determine the trajectory of an object, such as any of the objects 100, 300, 350, 400, 450, 500, 550, 600, 650, 900, 950 described above. In some examples, the object trajectory determiner 1002 determines the trajectory manually, such as based on input from a user or administrator. The object trajectory determiner 1002 can determine the trajectory of the object as described above with respect to the object trajectory synthesis stage 204 and/or user input trajectory processing stage 800.

In some implementations, the object trajectory determiner 1002 determines the trajectory of the object based on a predetermined mass of the object. In some implementations, the object trajectory determiner 1002 determines the trajectory of the object based on the mass of the object and an action. The action can be referred to as an action label, an action type, and/or an action description. The action can describe an interaction with the object by a hand or hands, such as the hand or hands holding, grabbing throwing, pushing, or rotating the object.

In some implementations, the object trajectory determiner 1002 determines the trajectory of the object based on the mass of the object and a random value. In some implementations, the random value has a gaussian distribution with a value between zero (0) and one (1). In some implementations, the object trajectory determiner 1002 determines the trajectory of the object based on the mass of the object, the action, and the random value. In some implementations, the object trajectory determiner 1002 determines the trajectory of the object by applying a denoising diffusion model to generate an animation of the object. The object trajectory determiner 1002 can determine the trajectory of the object by applying the denoising diffusion model to generate an animation of the object with any combination of the mass of the object, the action, and/or the random value as inputs to the denoising diffusion model. In some implementations, the object trajectory determiner 1002 implements the input trajectory processing stage 800 shown and described with respect to FIG. 8.

The computing system 1000 can include a hand motion determiner 1004. The hand motion determiner 1004 can determine motion of one or more hands, such as the hand 104 shown and described with respect to FIG. 1 and/or the hands 302, 304 shown and described with respect to FIGS. 3A through 6B. The hand motion determiner 1004 can determine the motion of the hand based on the mass of the object and the trajectory of the object. The hand motion determiner 1004 can perform any combination of the methods, techniques, and/or functions described above with respect to the hand motion synthesis stage 210. In some implementations, the hand motion determiner 1004 determines the motion of the hand based on the mass of the object, the trajectory of the object, and an action. The action can be referred to as an action type or an action description. The action can describe an interaction with the object by a hand or hands, such as the hand or hands holding, grabbing, throwing, pushing, or rotating the object.

In some implementations, the hand motion determiner 1004 determines the motion of the hand by applying a generative model such as a diffusion model. The diffusion model can include a hand denoising diffusion model. The hand motion determiner 1004 can determine the motion of the hand by applying the generative model with inputs that include any combination of the mass of the object, the trajectory of the object, the action, a random value representing noise, and/or a shape of the object. In some implementations the random value representing noise can have a gaussian distribution and a value between zero (0) and one (1).

The computing system 1000 can include an animation generator 1006. The animation generator 1006 can generate an animation that includes movement and/or trajectory of the object and movement and/or motion of the hand. The animation generator 1006 can generate the animation based on the trajectory of the object generated and/or determined by the object trajectory determiner 1002 and the motion of the hand determined by the hand motion determiner 1004.

The computing system 1000 can include a diffusion model 1008. The diffusion model 1008 is an example of a generative model and can include a denoising diffusion model that recreates an image and/or images by removing noise from the image and/or images. The diffusion model 1008 can be applied and/or called by the object trajectory determiner 1002 and/or hand motion determiner 1004. The diffusion model 1008 can be included in and/or distributed between the object trajectory synthesis stage 204, represented as the diffusion layers 206, and/or the hand motion synthesis stage 210, represented as the diffusion layers 214.

The computing system 1000 can include a neural network 1010. The neural network 1010 can include, for example, a convolutional neural network that modifies the trajectory of the object determined by the object trajectory determiner 1002 and/or modifies the movement of the hand determined by the hand motion determiner 1004. The neural network 1010 can be represented as the network 216.

The computing system 1000 can include a fitting model 1012. The fitting model 1012 can fit the motion of the hand to the trajectory of the object to generate a realistic animation. The fitting model 1012 can be represented as the fitting optimization stage 218.

The computing system 1000 can include at least one processor 1014. The at least one processor 1014 can execute instructions, such as instructions stored in at least one memory device 1016, to cause the computing system 1000 to perform any combination of methods, functions, and/or techniques described herein.

The computing system 1000 can include at least one memory device 1016. The at least one memory device 1016 can include a non-transitory computer-readable storage medium. The at least one memory device 1016 can store data and instructions thereon that, when executed by at least one processor, such as the processor 1014, are configured to cause the computing system 1000 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 1000 can be configured to perform, alone, or in combination with the computing system 1000, any combination of methods, functions, and/or techniques described herein.

The computing system 1000 may include at least one input/output node 1018. The at least one input/output node 1018 may receive and/or send data, such as from and/or to, a server or other computing device, and/or may receive input and provide output from and to a user. The input and output functions may be combined into a single node, or may be divided into separate input and output nodes. The input/output node 1018 can include a microphone, a camera, a display, a speaker, one or more buttons (such as a keyboard), a human interface device such as a mouse or trackpad, and/or one or more wired or wireless interfaces for communicating with other computing devices such as a server and/or the computing devices.

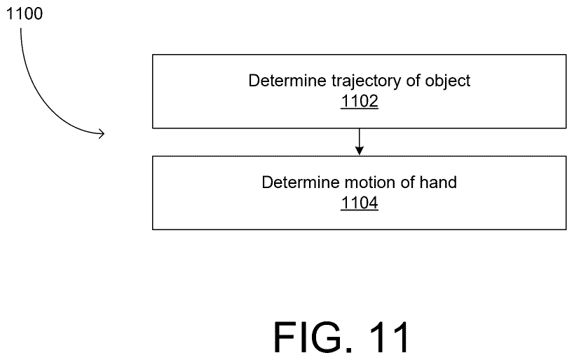

FIG. 11 is a flowchart showing a method 1100 for generating an animation of a hand interacting with an object based on a mass of the object. The method 1100 can be performed by a computing system such as the computing system 1000.

The method 1100 can include determining a trajectory of an object (1102). Determining the trajectory of the object (1102) can include determining the trajectory of the object based on a mass of the object. The method 1100 can include determining motion of a hand (1104). Determining the motion of the hand (1104) can include determining the motion of the hand based on the mass of the object and the trajectory of the object.

In some examples, the method 1100 further includes generating an animation of the hand interacting with the object based on the trajectory of the object and the motion of the hand.

In some examples, determining the motion of the hand includes applying a model to generate an animation of the hand with the mass of the object and the trajectory of the object as inputs to the model.

In some examples, determining the trajectory of the object includes applying a model to generate an animation of the object with the mass of the object and an action type as inputs to the model, the action type characterizing an action of the hand.

In some examples, determining the trajectory of the object includes generating a path of the object based on the mass of the object and random noise.

In some examples, determining the trajectory of the object includes generating a path of the object based on the mass of the object and random noise, and determining the trajectory of the object by removing the random noise from the path of the object.

In some examples, determining the trajectory of the object includes applying a trajectory denoising diffusion model to generate an animation of the object with the mass of the object and an action type as inputs to the trajectory denoising diffusion model, the action type characterizing an action of the hand, and determining the motion of the hand includes applying a hand denoising diffusion model to generate animation of the hand with the mass of the object and the animation of the object as inputs to the hand denoising diffusion model.

In some examples, determining the trajectory of the object includes applying a trajectory denoising diffusion model to generate an animation of the object with the mass of the object and an action type as inputs to the trajectory denoising diffusion model, the action type characterizing an action of the hand, and determining the motion of the hand includes applying a hand denoising diffusion model to generate the animation of the hand with the mass of the object, the action type, and the animation of the object as inputs to the hand denoising diffusion model.

In some examples, a number of contact points between the hand and the object is a function of the mass of the object.

In some examples, determining the motion of the hand includes synthesizing a set of three-dimensional hand joints and per-vertex hand contact probabilities, the per-vertex hand contact probabilities being a function of the mass of the object.

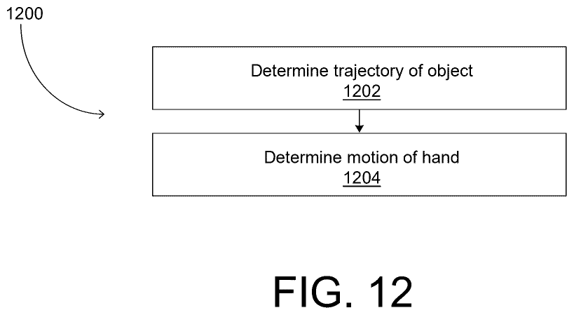

FIG. 12 is a flowchart showing a method 1200 for generating an animation of a hand interacting with an object. The method 1200 can be performed by a computing system such as the computing system 1000.

The method 1200 can include determining a trajectory of an object (1202). Determining the trajectory of the object (1202) can include determining the trajectory of the object by re-sampling a received path. The method 1200 can include determining a motion of a hand (1204). Determining the motion of the hand (1204) can include determining the motion of the hand based on a mass of the object and the trajectory of the object.

In some examples, determining the motion of the hand includes applying a model to generate an animation of the hand with the mass of the object and the trajectory of the object as inputs to the model.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
determining a trajectory of an object based on a mass of the object; and
determining a motion of a hand based on the mass of the object and the trajectory of the object.

2. The method of claim 1, wherein determining the motion of the hand includes applying a model to generate an animation of the hand with the mass of the object and the trajectory of the object as inputs to the model.

3. The method of claim 1, wherein determining the trajectory of the object includes applying a model to generate an animation of the object with the mass of the object and an action type as inputs to the model, the action type characterizing an action of the hand.

4. The method of claim 1, wherein determining the trajectory of the object includes generating a path of the object based on the mass of the object and random noise.

5. The method of claim 1, wherein:
determining the trajectory of the object includes applying a trajectory denoising diffusion model to generate an animation of the object with the mass of the object and an action type as inputs to the trajectory denoising diffusion model, the action type characterizing an action of the hand, and
determining the motion of the hand includes applying a hand denoising diffusion model to generate animation of the hand with the mass of the object and the animation of the object as inputs to the hand denoising diffusion model.

6. The method of claim 1, wherein:
determining the trajectory of the object includes applying a trajectory denoising diffusion model to generate an animation of the object with the mass of the object and an action type as inputs to the trajectory denoising diffusion model, the action type characterizing an action of the hand, and
determining the motion of the hand includes applying a hand denoising diffusion model to generate the animation of the hand with the mass of the object, the action type, and the animation of the object as inputs to the hand denoising diffusion model.

7. The method of claim 1, wherein a number of contact points between the hand and the object is a function of the mass of the object.

8. The method of claim 1, wherein determining the motion of the hand includes synthesizing a set of three-dimensional hand joints and per-vertex hand contact probabilities, the per-vertex hand contact probabilities being a function of the mass of the object.

9. A non-transitory computer-readable storage medium comprising instructions stored thereon that, when executed by at least one processor, are configured to cause a computing system to:
determine a trajectory of an object based on a mass of the object;
determine a motion of a hand based on the mass of the object and the trajectory of the object; and
generate an animation of the hand interacting with the object based on the trajectory of the object and the motion of the hand.

10. The non-transitory computer-readable storage medium of claim 9, wherein determining the motion of the hand includes applying a model to generate the animation of the hand with the mass of the object and the trajectory of the object as inputs to the model.

11. The non-transitory computer-readable storage medium of claim 9, wherein determining the trajectory of the object includes applying a model to generate an animation of the object with the mass of the object and an action type as inputs to the model, the action type characterizing an action of the hand.

12. The non-transitory computer-readable storage medium of claim 9, wherein:
determining the trajectory of the object includes applying a trajectory denoising diffusion model to generate an animation of the object with the mass of the object and an action type as inputs to the trajectory denoising diffusion model, the action type characterizing an action of the hand, and
determining the motion of the hand includes applying a hand denoising diffusion model to generate animation of the hand with the mass of the object and the animation of the object as inputs to the hand denoising diffusion model.

13. The non-transitory computer-readable storage medium of claim 9, wherein:
determining the trajectory of the object includes applying a trajectory denoising diffusion model to generate an animation of the object with the mass of the object and an action type as inputs to the trajectory denoising diffusion model, the action type characterizing an action of the hand, and
determining the motion of the hand includes applying a hand denoising diffusion model to generate animation of the hand with the mass of the object, the action type, and the animation of the object as inputs to the hand denoising diffusion model.

14. The non-transitory computer-readable storage medium of claim 9, wherein a number of contact points between the hand and the object is a function of the mass of the object.

15. The non-transitory computer-readable storage medium of claim 9, wherein determining the motion of the hand includes synthesizing a set of three-dimensional hand joints and per-vertex hand contact probabilities, the per-vertex hand contact probabilities being a function of the mass of the object.

16. A computing system comprising:
at least one processor; and
a non-transitory computer-readable storage medium comprising instructions stored thereon that, when executed by the at least one processor, are configured to cause the computing system to:
determine a trajectory of an object based on a mass of the object;
determine a motion of a hand based on the mass of the object and the trajectory of the object; and
generate an animation of the hand interacting with the object based on the trajectory of the object and the motion of the hand.

17. The computing system of claim 16, wherein determining the motion of the hand includes applying a model to generate the animation of the hand with the mass of the object and the trajectory of the object as inputs to the model.

18. The computing system of claim 16, wherein determining the trajectory of the object includes applying a model to generate an animation of the object with the mass of the object and an action type as inputs to the model, the action type characterizing an action of the hand.

19. The computing system of claim 16, wherein:
determining the trajectory of the object includes applying a trajectory denoising diffusion model to generate an animation of the object with the mass of the object and an action type as inputs to the trajectory denoising diffusion model, the action type characterizing an action of the hand, and
determining the motion of the hand includes applying a hand denoising diffusion model to generate animation of the hand with the mass of the object and the animation of the object as inputs to the hand denoising diffusion model.

20. The computing system of claim 16, wherein:
determining the trajectory of the object includes applying a trajectory denoising diffusion model to generate an animation of the object with the mass of the object and an action type as inputs to the trajectory denoising diffusion model, the action type characterizing an action of the hand, and
determining the motion of the hand includes applying a hand denoising diffusion model to generate animation of the hand with the mass of the object, the action type, and the animation of the object as inputs to the hand denoising diffusion model.

21. The computing system of claim 16, wherein a number of contact points between the hand and the object is a function of the mass of the object.

22. A method comprising:
determining a trajectory of an object by re-sampling a received path; and
determining a motion of a hand based on a mass of the object and the trajectory of the object.

23. The method of claim 22, wherein determining the motion of the hand includes applying a model to generate an animation of the hand with the mass of the object and the trajectory of the object as inputs to the model.
